(19) United States
(12) Patent Application Publication
(10) Pub. No.: US 2008/0259613 A1
(43) Pub. Date: Oct. 23, 2008

(54) COLORED OUTDOOR LOW VOLTAGE LIGHTING COVERS, LENSES, OR COLORED FIXTURE COVERS

(76) Inventors: John Blake, St. Charles, IL (US); William D. Pegg, Wilmette, IL (US)

Correspondence Address: John Blake, 6N715 McKay Drive, St. Charles, IL, 60175-6397, US

(21) Appl. No.: 12/103,259

(22) Filed: Apr. 15, 2008

Related U.S. Application Data
(60) Provisional application No. 60/923,757, filed on Apr. 17, 2007.

(51) Int. Cl. F21V 11/00

(52) U.S. Cl. 362/351

(57) ABSTRACT

A method for altering a color of a light source includes the acts of covering at least a portion of a light source with a flexible, colored material, and removably affixing the flexible, colored material adjacent the light source to alter the color of the light output from the light source.

### CROSS REFERENCE TO RELATED APPLICATIONS

This application claims the priority of U.S. Provisional Patent Application No. 60/923,757, filed Apr. 17, 2007, naming John Blake as an inventor, and entitled “Colored Outdoor Low Voltage Lighting Covers, Lenses, Or Colored Fixture Covers” which is incorporated by reference in its entirety.

### FIELD OF THE INVENTION

The present invention relates generally to light sources and light emitted thereby.

### BACKGROUND OF THE INVENTION

Outdoor lighting used for the purpose of enhancing outdoor landscaping, decorations, buildings, and for the purpose of lighting pathways for safety, typically use white lights.

FIG. 1 shows a representation of one type of white light for outdoor use, a Malibu light fixture LT9. This fixture is a typical 20 W flood light used for residential or commercial outdoor decorative or safety lighting applications. The light fixture 10 comprises a head 15 bearing a light source (not shown) emanating light 50. The light rays 50 emanating therefrom are shown to present a white spot 60 on a surface. The light fixture 10 includes a stake 20 comprising a pointed end 30 suitable for fixation in the ground, as is shown and indicated by the dashed lines. Electrical source 40 is also connected to the light fixture 10 via a power cord to power the light.

During holidays or on special occasions, to celebrate the holiday or occasion, many people find it desirable to project or decorate with different color lights that are symbolic to the particular holiday being celebrated. For example at Christmas the colors red or green are typically used for decorations and therefore are symbolic to this holiday. Thus there is a tendency to use these colors in lighting decorations for this holiday. In the United States on the 4^{th} of July, Red White, and Blue are typically used and holiday decorations typically reflect these colors.

Decorating with colored lighting outdoors has become more and more prevalent over the years. Most colored lighting used for decorations must be purchased in the form of strands of miniature or small lights that must be manually hung from landscaping, buildings, or structures. Other forms include specially colored light bulbs or fixtures. In any case these decorations are constructed and removed on every occasion and at times involve a significant amount of work and effort as an elaborate network of power cables is generally required to power the lights. These lighting systems can also become very costly, especially if decorations are changed from holiday to holiday and year to year. Other forms of outdoor lighting decorations take the shape of objects that symbolize the particular holiday or event being celebrated. For example, there exist many shapes and forms of Santa Clause statues constructed from colored plastic and illuminated with incandescent lighting. Also very popular for the Christmas season is wire form statues lined with miniature lights. The most popular statues are deer and snowmen.

Over time it has become increasingly popular to install permanent, lighting systems to enhance landscaping, building, structures, of to enhance safety by improving visibility using these lighting systems. The color of light for these systems is typically white.

Alternative color options, and therefore prior art, is limited to plastic or glass lens covers designed specifically for the type and model light fixture such as those sold by Wac Lighting for use with MR11 lights. Other lenses sold by CCL Lighting for use with their Baby Light Kit are specifically designed to fit only these lights. Other art consists of colored fixtures that take the form of complete decorations representing something symbolic to the holiday or occasion. Further art takes the form of colored strands of lights or specially colored light bulbs. These types of decorations are represented in U.S. Pat. Nos. 6,155,695, 5,567,045, and 6,966,680. These specific solutions are not widely available for most fixtures available on the market.

One of the disadvantages of the prior art is the lack of universality of the colored lenses or light bulbs as these solutions are specific to the type and model fixture. Another disadvantage is the time and money involved in adding color to outdoor lighting for landscaping, structures, and decorations. Unique decorations using colored lighting must be purchased for each holiday in the forms mentioned above. These decorations involve manual installation including hanging of the lights and managing the power cord network required to supply power for the lights. Furthermore, these lighting systems are typically controlled manually and therefore must be turned on and off at dusk and dawn unless light timers are used. Yet a third disadvantage is the dismantling of the fixture involved to alter the color using the colored lenses or light bulbs.

Accordingly, there exists a need for a universal solution that will temporarily alter the color of the light projected or dispersed by temporary or existing light sources.

### SUMMARY OF THE INVENTION

To address the need identified above, the present concepts include, in at least some aspects, a method for altering a color of a light source comprising the acts of covering at least a portion of a light source with a flexible, colored material, and removably affixing the flexible, colored material adjacent the light source to alter the color of the light output from the light source.

In still another aspect, the present concepts include a colored lighting system, comprising a light source, a housing for the light source, a colored material configured to at least substantially conform to the housing, and an attachment member for removably attaching the flexible, colored material to the housing to alter the color of the light output from the housing.

In yet another aspect of the present concepts, a colored lighting system, comprises a light source, a colored material configured to at least substantially conform to a shape of the light source, and an attachment member for removably attaching the flexible, colored material to the light source to alter the color of the light output from the light source.

In another aspect of the present concepts, a colored lighting system comprises a light source disposed within a housing comprising at least one lens and/or at least one pane through which light output from the light source is transmitted, a colored material configured to at least substantially conform to a shape of at least one of the housing and/or the at least one lens and/or at least one pane, and an attachment member for removably attaching the flexible, colored material to the at least one of the housing and/or the at least one lens and/or at least one pane to alter the color of the light output therefrom.

The above summary of the present invention is not intended to represent each embodiment or every aspect of the present invention. Additional features and benefits of the invention will become apparent from the detailed description, figures and claims set forth below.

### BRIEF DESCRIPTION OF THE DRAWINGS

FIG. 1 is a depiction of a typical outdoor low voltage floodlight casting a spot of illumination on a surface.

FIGS. 2(a)-2(b) are depictions of the outdoor floodlight utilizing one embodiment of the present concepts to output a colored illumination.

FIG. 3 is a depiction of the outdoor floodlight utilizing another embodiment of the present concepts to output a colored illumination.

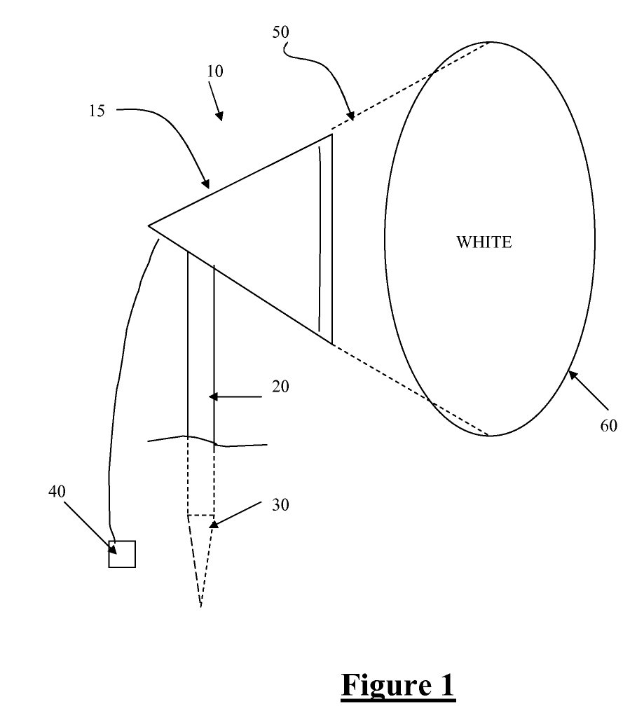

### DETAILED DESCRIPTION OF THE INVENTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

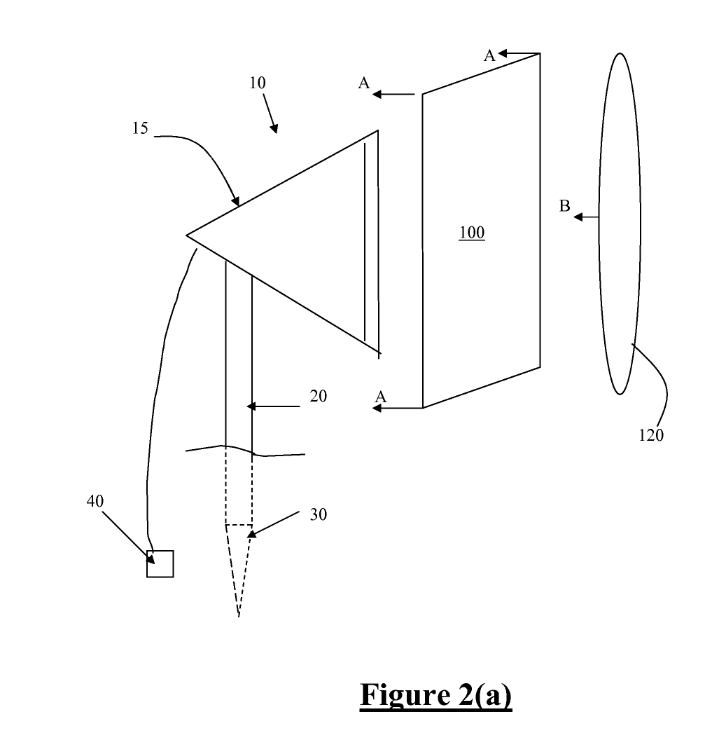

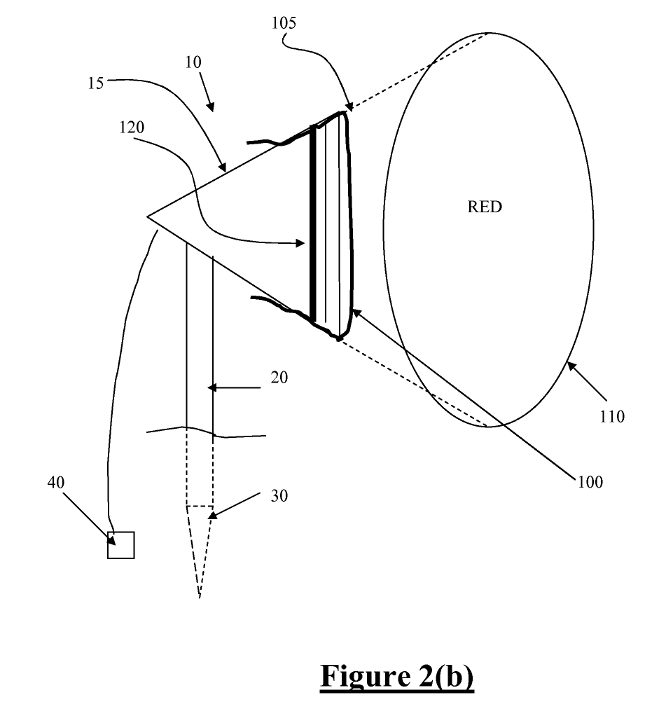

Referring to FIG. 2(a), a flexible sheet of thin, substantially transparent, colored material (“colored sheet”) 100 is depicted. In at least one embodiment, the colored sheet 100 is a 16″ square piece of material. The colored sheet 100 may include any shape (e.g., square, rectangular, oval, circular, etc.) and/or size and any color.

The material may advantageously possess cutouts or openings having a pattern or discernible shape so that the light output therethrough conveys such shape on a surface receiving the incident light. For example, in some applications, the sheet may be a black sheet with cutouts of a desired shape (or transparent sections in the sheet) selected to cause either projection of light of that shape, or in approximation thereof, and/or to enable a viewer of the light source itself to clearly make out the light in the desired shape. Thus, if the shapes cut out of or formed in the black sheet are stars, then the viewer of the light source will see glowing stars and will see projections thereof. Likewise, the converse holds and the colored sheet 100 in accord with other aspects of the present concepts can utilize a transparent sheet with opaque shapes so as to cast shadows of the desired shape.

The material used in the colored sheet 100 may comprise, but is not limited to, a vinyl, Mylar, cellophane, polyester, polypropylene, polyethylene and/or other flexible material that is transparent or translucent, in whole or in part. The material may be of a single color or multiple colors, such as may be arranged in a pattern (e.g., a flag, an icon, etc.) or randomly (e.g., to form random splotches of color). In one embodiment of the present concepts (not shown) the colored sheet 100 may comprise one or more designs, figures, text, characters, and/or objects stenciled out or formed in the colored sheet, such as in the center of the sheet. When the colored sheet 100 is placed over a light source, such as a floodlight lens, with the stenciled portion centered in the beam projected by the fixture, the designs, figures, text, characters, and/or objects can be projected onto a wall or other surface. Moving the light fixture further from the wall or surface increases the size of the object or text projected.

As noted above, the color of the colored sheet 100 can be any color or combination of colors desired. Exemplary, non-limiting colors include red, green, blue, yellow, orange, light blue, light green, or pink, as these colors are most representative of the colors used for decorations for most holidays celebrated. Multiple colors may be used, optionally in a pattern or image, to provide more complex presentations. Likewise, multiple colored sheets 100 may be used to combine colors or to produce unique effects (e.g., layering multiple colored sheets 100 having patterns so as to produce a different pattern).

FIG. 2(a) shows one type of attachment/securing member 120 for the colored sheet 100. Specifically, FIG. 2(a) shows an attachment member 120 consisting of an elastic band, such as but not limited to a rubber band. In one embodiment, for use with an outdoor light, the attachment member 120 is a rubber band 2″ in diameter, 0.25 inches wide and 0.060 inches thick. In another embodiment, the attachment member 120 is a rubber band having a 2″ diameter, ⅜″ width and 0.080″ thickness. For these examples, the attachment members 120 are adapted to stretch to about 6″ in diameter to facilitate attaching of the colored sheet 100 to a variety of light sources (e.g., the entire light source 10) or portions of light sources (e.g., just the light source head 15 or a portion thereof). The arrows “A” at the corners of the colored sheet 100 indicate a direction of movement of the sheet as it is placed over at least a portion of the light source 10 head 15, whereupon the arrow “B” indicates the placement of the attachment member 120 over the colored sheet to quickly and easily secure the colored sheet to the light source head 15. FIG. 2(b) shows one example of an outdoor light source 10 having a colored sheet 100 in accord with at least some aspects of the present concepts attached to a portion of the head 15 of the light source by attachment member 120. The light rays 105 emanating therefrom are shown to present a red spot 110 on a surface.

In other alternate embodiments, the attachment member 120 may comprise a string or other woven material, a plastic band, or a wire. In embodiments where the attachment member 120 is a plastic band, such plastic band may comprise mating engagement members such as slots into which an end of the plastic band may be passed and secured, such as by projections on the plastic band (e.g., teeth) or pins that may be inserted into correspondingly formed holes or recesses disposed along at least a portion of the plastic band. Alternatively, a buckle or clasp may be provided so that the plastic band, once positioned, may be tightened to secure the colored sheet to the light source or light source housing. In still other aspects, the attachment member 120 may comprise VELCRO™ disposed on the light source 10 or light source head 15 and on the colored sheet. In yet other aspects, the attachment member 120 may comprise an adhesive or tacky material applied to the light source and/or on light source housing and/or the colored sheet.

In yet other aspects, the attachment member 120 may comprise clips, bands, straps, snaps (e.g., plastic snaps integrated with the colored sheet or clamped thereon, etc.), clamps, hasps, tape, elastic strips, mating male/female connectors, magnets (e.g., neodymium magnets, etc.), suction cups, barbs, hooks, stakes, and/or even weights (e.g., to provide a simple draping covering over a light).

In yet another embodiment, the colored sheet 100 may comprise a heat-sensitive shrink wrap material or cello wrap, such as, but not limited to, a polymer plastic (e.g., a PVC with polyester(s)). With such a material, the user could apply the colored sheet over the light source or light housing and apply heat using a heat source, such as a blow dryer, to cause the colored sheet to shrink about and generally conform to the shape of the light source or light housing. Alternatively, the colored sheet 100 may be configured to utilize the heat of the light source itself to shrink to generally conform to the light.

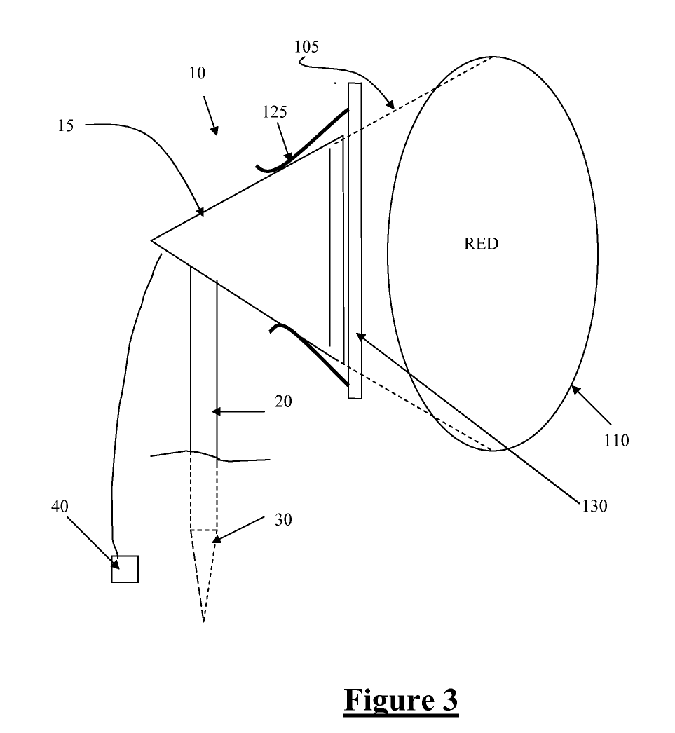

FIG. 3 shows yet another embodiment wherein the colored sheet 100 is semi-rigid or rigid and comprises attachment members 125 in the form of spring steel or plastic clamps that are outwardly biased upon affixation to the light source 10 head 15 so as to provide a clamping force thereagainst. The light rays 105 emanating therefrom are shown to present a red spot 110 on a surface.

As noted above, the light source may comprise any light source. In one example, the light source may comprise an illuminated walkway post light manufactured by Enchanted Garden, P/N 3430910. In other examples, the light source may comprise a floor lamp, a table lamp, a desk lamp, a ceiling light, a ceiling light can, a flashlight, a lantern, or a computer USB light. The present concepts thus apply to any exterior or interior light source, whether the entire light source or only a portion thereof (e.g., over a lamp shade). In some aspects, the colored sheets may even be temporarily installed over underwater lighting, such as those used in pools (e.g., using suction cups).

Thus, in accord with the system and method described herein, a homeowner, business owner, or any other individual may easily affix and/or remove colored sheets 100, as disclosed above, to various outdoor and/or indoor lighting fixtures or portable light sources, as desired to produce a desired color effect, pattern, image, sign, advertisement, or the like. For example, a person may, at the beginning of a holiday season, event, or the like, may put the colored sheets 100 on outdoor lights using attachment members 100 and, at the conclusion of the holiday season or event, simply remove and discard (or keep) the colored sheets. Such colored sheets 100 may, for example, be used to reflect a favorite sports team (e.g., team colors, team mascot, etc.), country (e.g., flag), holiday (e.g., red and/or green for Christmas). During various holidays or special occasion it is desirable to alter the color of these lighting systems to project or diffuse colors symbolic to the holiday or event. As noted above, the colored sheets 100 may comprise transparent portions, opaque portions, or cut-outs in the form of images, symbols or words symbolic to the holiday or occasion celebrated. These images, symbols or words can be projected on building walls using existing low voltage flood lights.

The colored sheets 100, as disclosed herein, may be applied to, for example, permanent networks of outdoor lighting, originally installed for the purpose landscape, building, structure, or general decoration or safety.

The present concepts provide a simple, low cost, and accessible decorative solution that is both easy to install and easy to remove.

While the invention is susceptible to other modifications and alternative forms, specific embodiments thereof have been shown by way of example in the figures and herein described in detail. For example, in one aspect, the colored sheet 100 and attachment member 120 may be integrated together in the form of a translucent colored suction cup that is sized to partially or completed occlude white light from emanating from an underwater pool light. The colored suction cup may easily and effectively be applied over a pool light so as to provide a color effect for the pool (e.g., for a party or season) and may be readily removed. Further, in yet other aspects, the colored sheet 100 may be sized and configured for application over any translucent media so as to alter the color of light passing through that media (e.g., a house window, a car window). Thus, the colored sheet 100 is not limited only to powered light sources. In such embodiments, the colored sheet 100 may be advantageously disposed against the surface of the glass using one or more attachment members, such as are described above, or even using static electricity (e.g., glass being very positive and Polypropylene and Polyethylene being very negative in the triboelectric series). The colored sheets 100 may be pre-charged with some charge or may be configured to develop a small negative charge upon removal from a package. It is to be understood, however, that the examples provided for illustration herein are not intended to limit the invention to the particular forms disclosed, but on the contrary, the intention is to cover all modifications, equivalents, and alternatives falling within the spirit and scope of the invention as defined by the appended claims.

What is claimed is:

1. A method for altering a color of a light source comprising the acts of:
covering at least a portion of a light source with a flexible, colored material; and
removably affixing the flexible, colored material adjacent the light source to alter the color of the light output from the light source.

2. The method of claim 1, wherein the light source comprises a low voltage outdoor lighting light source.

3. The method of claim 1 wherein the flexible, colored material comprises a sheet of vinyl, Mylar, cellophane, polyester, polypropylene, or polyethylene.

4. The method of claim 1, wherein said act of removably affixing the flexible, colored material adjacent the light source comprises wrapping the flexible, colored material around at least a portion of the light source and biasing the material against the light source using an elastic band.

5. The method of claim 1, wherein said act of removably affixing the flexible, colored material adjacent the light source comprises wrapping the flexible, colored material around at least a portion of the light source and biasing the material against the light source using a plastic band.

6. The method of claim 1, wherein said act of removably affixing the flexible, colored material adjacent the light source comprises wrapping the flexible, colored material around at least a portion of the light source and biasing the material against the light source using an flexible band comprising a securing member.

7. The method of claim 6, wherein said securing member comprises mating engagement members.

8. The method of claim 7, wherein said securing member comprises Velcro, an adhesive, a string, or a woven material.

9. The method of claim 1, wherein said act of removably affixing the flexible, colored material adjacent the light source comprises wrapping the flexible, colored material around at least a portion of the light source and biasing the material against the light source using a wire member.

10. The method of claim 1, wherein said act of removably affixing the flexible, colored material adjacent the light source comprises engaging an adhesive member disposed on the flexible, colored material and/or on the light source to the other one of the flexible, colored material and/or the light source.

11. The method of claim 1, wherein said flexible, colored material comprises a single color.

12. The method of claim 1, wherein said flexible, colored material comprises a plurality of colors.

13. The method of claim 1, wherein said flexible, colored material comprises a pattern.

14. The method of claim 1, wherein said flexible, colored material comprises an image.

15. The method of claim 1, wherein said flexible, colored material comprises at least one cutout or opening.

16. The method of claim 15, wherein said flexible, colored material comprises one or more cutouts or openings forming a pattern.

17. The method of claim 15, wherein said flexible, colored material comprises one or more transparent portions forming a pattern in the colored material.

18. The method of claim 1, wherein said flexible, colored material comprises a light transmitting portion and a light blocking portion, the light blocking portion being formed in a predefined pattern, shape, text, or alphanumeric representation.

19. A colored lighting system, comprising:
a light source;
a housing for said light source;
a colored material configured to at least substantially conform to said housing; and
an attachment member for removably attaching the flexible, colored material to said housing to alter the color of the light output from the housing.

20. A colored lighting system, comprising:
a light source;
a colored material configured to at least substantially conform to a shape of said light source; and
an attachment member for removably attaching the flexible, colored material to said light source to alter the color of the light output from the light source.
